(19) United States
(12) Patent Application Publication
(10) Pub. No.: US 2024/0326263 A1
(43) Pub. Date: Oct. 3, 2024

(54) SYSTEMS AND METHODS FOR CHANGING AN END EFFECTOR FOR A ROBOTIC ARM

(71) Applicant: Warsaw Orthopedic, Inc., Warsaw, IN (US)

(72) Inventors: Daniel Paxton Wall, Cordova, TN (US); Adam David Glaser, Collierville, TN (US)

(21) Appl. No.: 18/617,790

(22) Filed: Mar. 27, 2024

Related U.S. Application Data
(60) Provisional application No. 63/455,697, filed on Mar. 30, 2023.

(51) Int. Cl. B25J 15/04

(52) U.S. Cl. CPC B25J 15/0408

(57) ABSTRACT

Systems and methods for changing an end effector for a robotic arm are provided. The system may include an adaptor having an adaptor plate having a kinematic interface having at least one projection extending from both the first side and the second side. The adaptor may also include a torque sleeve retained on the adapter plate and a screw disposed inside of the torque sleeve. The system may also include an end effector having a kinematic receiver and a nut. The kinematic receiver may include at least one recess for receiving a corresponding projection of the at least one projection. The screw may be secured to a robot flange and the nut may be secured to the torque sleeve, thereby securing the end effector, the adaptor, and the robot flange to each other.

### CROSS-REFERENCE TO RELATED APPLICATION

This application claims the benefit of and priority to U.S. Provisional Patent Application No. 63/455,697 filed Mar. 30, 2023, the entire disclosure of which is incorporated by reference herein.

### BACKGROUND

The present disclosure is generally directed to adaptors, and relates more particularly to an adaptor for changing end effectors on a robotic arm.

Surgical robots may assist a surgeon or other medical provider in carrying out a surgical procedure, or may complete one or more surgical procedures autonomously. Providing controllable linked articulating members allows a surgical robot to reach areas of a patient anatomy during various medical procedures.

### BRIEF SUMMARY

Example aspects of the present disclosure include:

A system for changing an end effector according to at least one embodiment of the present disclosure comprises an adaptor comprising: an adaptor plate having a first side, a second side opposite the first side, and a kinematic interface, the kinematic interface including at least one projection extending from both the first side and the second side; a torque sleeve retained on the adapter plate; and a screw disposed inside of the torque sleeve; an end effector having a body, a kinematic receiver disposed on the body, and a nut, the kinematic receiver including at least one recess for receiving a corresponding projection of the at least one projection of the second side, and wherein the screw is secured to a robot flange and the nut is secured to the torque sleeve, thereby securing the end effector, the adaptor, and the robot flange to each other.

Any of the aspects herein, further comprising a robot flange having a first kinematic receiver, the first kinematic receiver including at least one recess for receiving a corresponding projection of the at least one projection of the first side.

Any of the aspects herein, wherein the kinematic receiver of the end effector is a second kinematic receiver, and wherein the kinematic interface is received by the first kinematic receiver and the second kinematic receiver when the adaptor plate is positioned between the robot flange and the end effector body.

Any of the aspects herein, wherein a surface of the robot flange is rectangular with a pair of cutouts on opposing sides, wherein the adapter plate comprises a pair of plate tabs configured to engage with the pair of cutouts when the adapter plate is positioned on the robot flange.

Any of the aspects herein, wherein the nut comprises a star drive configured to receive a star driver, the star driver configured to drive the nut onto the screw.

Any of the aspects herein, wherein the torque sleeve comprises a patterned flange.

Any of the aspects herein, wherein the body of the end effector has a patterned cutout for receiving the patterned flange, wherein the nut can be secured to the screw when patterned flange is received by the patterned cutout.

Any of the aspects herein, wherein patterned cutout and the patterned flange each form a star pattern.

Any of the aspects herein, wherein the torque sleeve comprises a pair of aligning tabs and the body of the adapter includes a seat for receiving the pair of aligning tabs.

Any of the aspects herein, wherein the adaptor plate further comprises at least one protrusion and the torque sleeve comprises at least one slot configured to receive the at least one protrusion to control rotation of the torque sleeve about the adaptor plate.

Any of the aspects herein, wherein the end effector comprises a plurality of end effectors, and wherein the adaptor is configured to receive any one end effector of the plurality of end effectors.

Any of the aspects herein, wherein the end effector comprises at least one pin to retain the nut in the body.

A system for changing an end effector according to at least one embodiment of the present disclosure comprises an adaptor comprising: an adaptor plate having a first side, a second side opposite the first side, and a kinematic interface, the kinematic interface including at least one projection extending from both the first side and the second side; a torque sleeve retained on the adapter plate, wherein the torque sleeve comprises a patterned flange; and a screw disposed inside of the torque sleeve; an end effector having a body, a kinematic receiver disposed on the body, and a nut, the kinematic receiver including at least one recess for receiving a corresponding projection of the at least one projection of the second side, the body having a patterned cutout for receiving the patterned flange, and wherein the nut can be secured to the screw when the patterned flange is received in the patterned cutout, and wherein the screw is secured to a robot flange and the nut is secured to the torque sleeve, thereby securing the end effector, the adaptor, and the robot flange to each other.

Any of the aspects herein, further comprising a robot flange having a first kinematic receiver, the first kinematic receiver including at least one recess for receiving a corresponding projection of the at least one projection of the first side.

Any of the aspects herein, wherein the kinematic receiver of the end effector is a second kinematic receiver, and wherein the kinematic interface is received by the first kinematic receiver and the second kinematic receiver when the adaptor plate is positioned between the robot flange and the end effector body.

Any of the aspects herein, wherein a surface of the robot flange is rectangular with a pair of cutouts on opposing sides, wherein the adapter plate comprises a pair of plate tabs configured to engage with the pair of cutouts when the adapter plate is positioned on the robot flange.

Any of the aspects herein, wherein the end effector comprises a plurality of end effectors, and wherein the adaptor is configured to receive any one end effector of the plurality of end effectors.

Any of the aspects herein, wherein the end effector comprises at least one pin to retain the nut in the body.

Any of the aspects herein, wherein the nut comprises a star drive configured to receive a star driver, the star driver configured to drive the nut onto the screw.

A system for changing an end effector according to at least one embodiment of the present disclosure comprises an adaptor comprising: an adaptor plate having a first side, a second side opposite the first side, and a kinematic interface, the kinematic interface including at least one projection extending from both the first side and the second side; a torque sleeve retained on the adapter plate; and a screw disposed inside of the torque sleeve; a robot flange having a first kinematic receiver, the first kinematic receiver including at least one recess for receiving a corresponding projection of the at least one projection of the first side; an end effector having a body and a second kinematic receiver disposed on the body, the second kinematic receiver including at least one recess for receiving a corresponding projection of the at least one projection of the second side; and a nut configured to secure to the torque sleeve, wherein the kinematic interface is received by the first kinematic receiver and the second kinematic receiver when the adaptor plate is positioned between the robot flange, and wherein the screw is secured to the robot flange and the nut is secured to the torque sleeve, thereby securing the end effector, the adaptor, and the robot flange to each other.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE SEVERAL VIEWS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is an isometric view of a system according to at least one embodiment of the present disclosure;

FIG. 2 is an isometric view of a system according to at least one embodiment of the present disclosure;

FIG. 3 is an isometric view of a robot flange according to at least one embodiment of the present disclosure;

FIG. 4 is a front view of the robot flange of FIG. 3 according to at least one embodiment of the present disclosure;

FIG. 5 is a side view of the robot flange of FIG. 3 according to at least one embodiment of the present disclosure;

FIG. 6 is an exploded view of an adaptor according to at least one embodiment of the present disclosure;

FIG. 7 is an isometric view of the adaptor of FIG. 6 according to at least one embodiment of the present disclosure;

FIG. 8 is a rear tilted view of the adaptor of FIG. 6 according to at least one embodiment of the present disclosure;

FIG. 9 is a front view of the adaptor of FIG. 6 according to at least one embodiment of the present disclosure;

FIG. 10 is a side view of the adaptor of FIG. 6 according to at least one embodiment of the present disclosure;

FIG. 11 is an exploded view of an end effector according to at least one embodiment of the present disclosure;

FIG. 12 is an isometric view of the end effector of FIG. 11 according to at least one embodiment of the present disclosure;

FIG. 13 is a rear tilted view of the end effector of FIG. 11 according to at least one embodiment of the present disclosure;

FIG. 14 is a front view of the end effector of FIG. 11 according to at least one embodiment of the present disclosure;

FIG. 15 is a rear view of the end effector of FIG. 11 according to at least one embodiment of the present disclosure;

FIG. 16 is a side view of the end effector of FIG. 11 according to at least one embodiment of the present disclosure;

FIG. 17 is a side cross-sectional view of the adaptor according to at least one embodiment of the present disclosure;

FIG. 18 is a side cross-sectional view of the adaptor engaged with the robot flange according to at least one embodiment of the present disclosure;

FIG. 19 is a top cross-sectional view of the end effector;

FIG. 20 is a top cross-sectional view of the end effector disengaged with the adaptor and the robot flange according to at least one embodiment of the present disclosure;

FIG. 21 is a top cross-sectional view of the end effector engaged with the adaptor and the robot flange according to at least one embodiment of the present disclosure;

FIG. 22 is a side cross-sectional view of the end effector engaged with the adaptor and the robot flange according to at least one embodiment of the present disclosure;

FIG. 23 is an isometric view of an adaptor according to at least one embodiment of the present disclosure;

FIG. 24 is an isometric view of a torque sleeve of the adaptor of FIG. 23 according to at least one embodiment of the present disclosure;

FIG. 25 is a front tilted view of the torque sleeve at a first angle relative to the adaptor of FIG. 23 according to at least one embodiment of the present disclosure;

FIG. 26 is a front tilted view of the torque sleeve at a second angle relative to the adaptor of FIG. 23 according to at least one embodiment of the present disclosure;

FIG. 27 is a rear tilted view of an end effector according to at least one embodiment of the present disclosure;

FIG. 28 is an isometric view of the end effector of FIG. 27 according to at least one embodiment of the present disclosure;

FIG. 29 is an exploded view of the end effector of FIG. 27 according to at least one embodiment of the present disclosure;

FIG. 30 is a side tilted view of the end effector of FIG. 27 and the adaptor of FIG. 23 mounted onto a robot flange according to at least one embodiment of the present disclosure;

FIG. 31 is a side tilted view of the end effector of FIG. 27 engaged with the adaptor of FIG. 23 mounted onto a robot flange according to at least one embodiment of the present disclosure;

FIG. 32 is a top cross-sectional view of the end effector of FIG. 27, the adaptor of FIG. 23, and the robot flange engaged with each other according to at least one embodiment of the present disclosure; and

FIG. 33 is a top cross-sectional view of the end effector of FIG. 27 disengaged from the adaptor of FIG. 23 and the robot flange with each other according to at least one embodiment of the present disclosure; and

FIG. 34 is a flowchart according to at least one embodiment of the present disclosure.

### DETAILED DESCRIPTION

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device and/or a medical device.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The terms proximal and distal are used in this disclosure with their conventional medical meanings, proximal being closer to the operator or user of the system, and further from the region of surgical interest in or on the patient, and distal being closer to the region of surgical interest in or on the patient, and further from the operator or user of the system.

During a surgical procedure an end effector attached to a robotic arm may be used to guide one or more tools during the procedure. The end effector may be, for example, an arm guide, which may be typically limited to certain diameters or geometries and different end effectors may be used for tools of different diameters. For example, one end effector may have an inner diameter of about 20 mm and another end effector may have an inner diameter of about 5 mm. It will be appreciated that in other embodiments the end effector(s) may have an inner diameter greater or less than 20 mm or 5 mm. It will be appreciated that in other embodiments, the instrument bore 112 may be of any shape, geometry, or size that can be fixed or varied to accommodate instruments of different sizes Such end effectors may be used, for example, to place screws or head assemblies of different sizes. Thus, in some instances it may be desirable to change the end effector during a surgical procedure to accommodate tools of different diameters. However, conventional systems are unable to change the end effectors as removal of the end effector may break the sterile barrier, introduce tolerance stack-up, or reduce an accuracy of the system.

At least one embodiment of the present disclosure provides for a system in which end effectors can be changed on a robotic arm without breaking the sterile barrier. The system may include an adaptor having a floating adaptor plate capable of engaging with different end effectors. The adaptor plate also eliminates undesired torque applied to the adaptor, which may negatively affect accuracy of the robot. The floating adaptor plate includes a torque sleeve and a screw through which the torque is applied to. Further, the adaptor plate does not contribute to tolerance stack up, thereby increasing accuracy of the robot.

Embodiments of the present disclosure provide technical solutions to one or more of the problems of (1) changing end effectors while maintaining a sterile barrier, (2) changing end effectors without affecting an accuracy of the system, and (3) changing end effectors without applying undesired torque to the system.

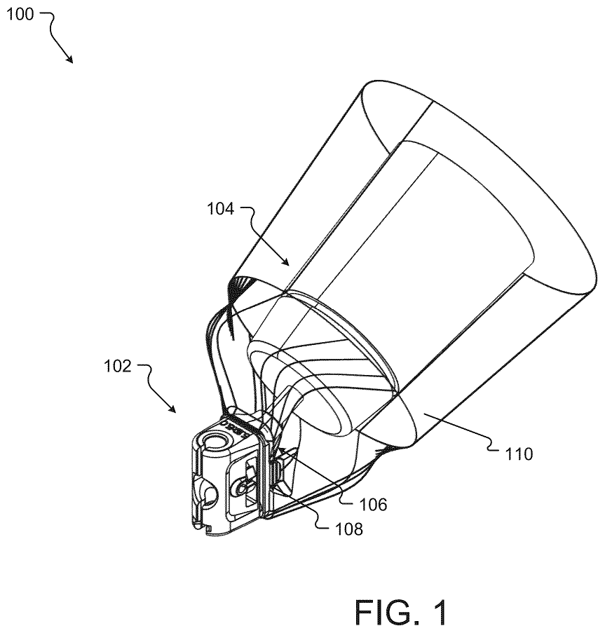

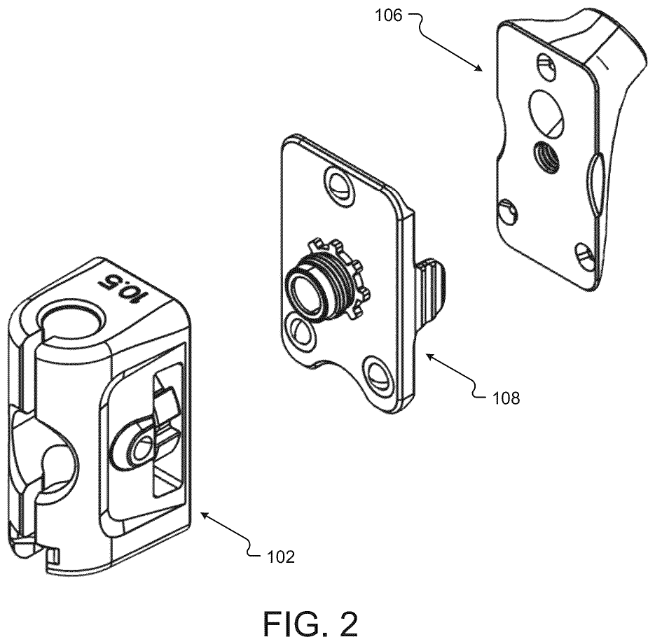

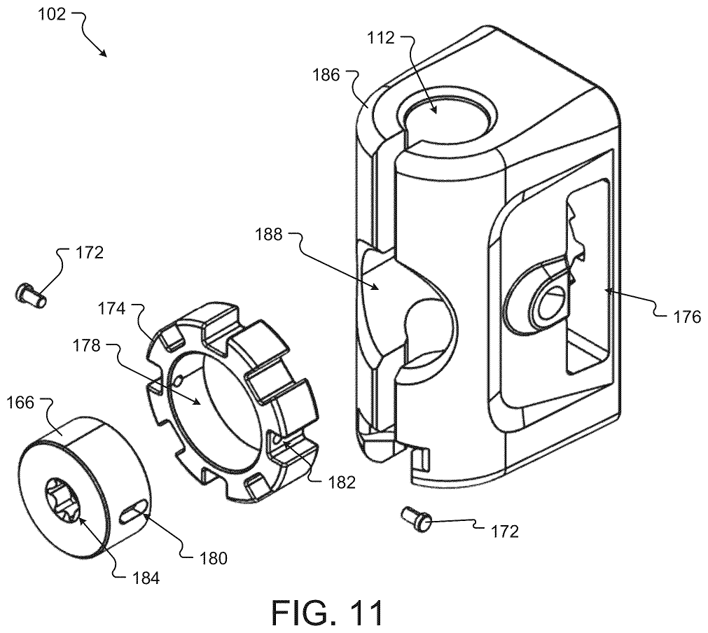

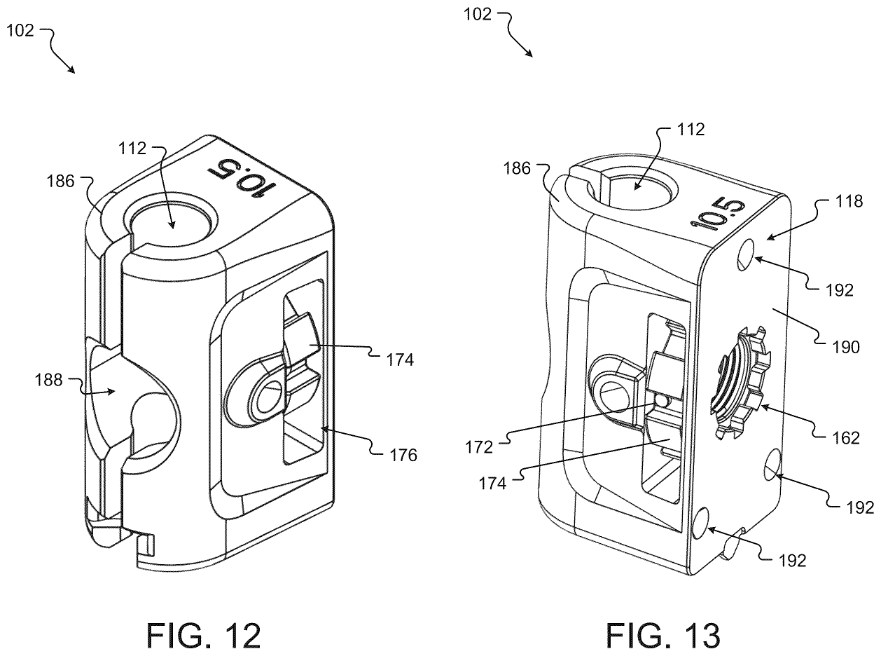

Turning first to FIGS. 1 and 2, an isometric image of a system 100 for changing an end effector 102 (which may be, for example, an arm guide) connected to a robotic arm 104 and an exploded view of the system 100 are respectively shown. The system 100 includes the end effector 102, a robot flange 106, and an adaptor 108. The end effector 102 can be removably coupled to the robot flange 106, which is connected to the robotic arm 104, while maintaining a sterile boundary between the robotic arm 104 (which may not be sterile) and a sterile environment (such as, for example, a surgical site on a patient). A drape 110 may be positioned between the robot flange 106 and the adaptor 108 to maintain the sterile environment. The system 100 enables the end effector 102 to be switched or changed with another end effector 102 during, for example, a surgical procedure in which multiple tools may be used by the robotic arm 104. This is beneficial as multiple tools of varying sizes may be used during a surgical procedure and the end effector 102 may accommodate tools of a limited diameter. More specifically, the end effector 102 has an instrument bore 112 (identified in FIGS. 11-13) by which to receive an instrument or tool. An inner diameter of the instrument bore 112 may vary across different end effectors 102 to accommodate instruments or tools of different sizes. Thus, it may be desirable to change the end effector 102 to use a different instrument or tool during the surgical procedure.

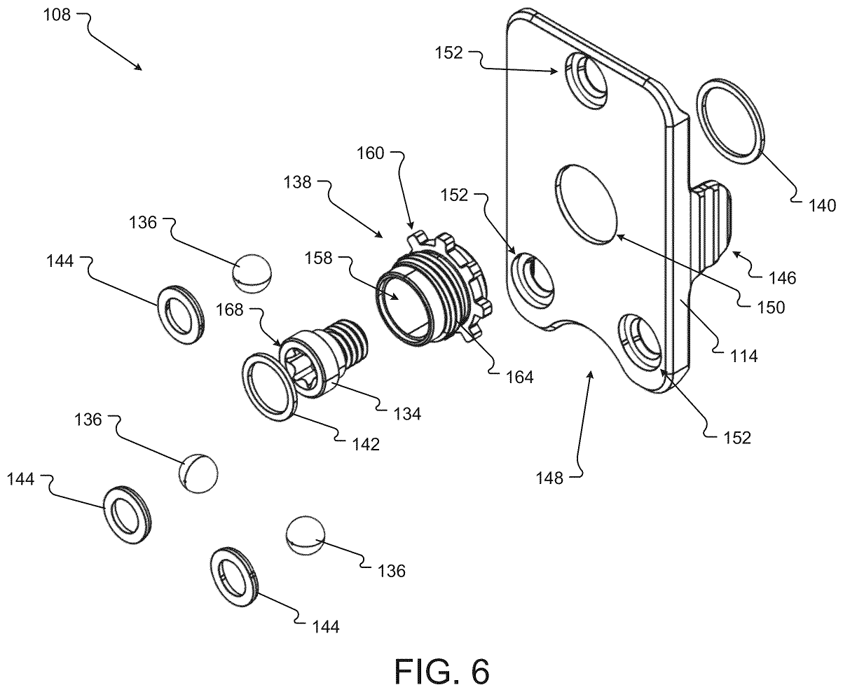

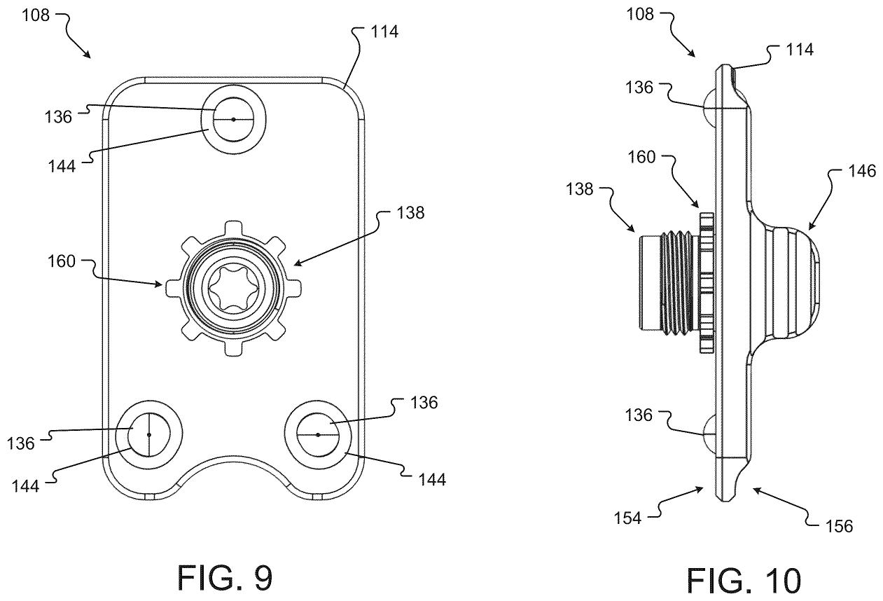

In some embodiments, the adaptor 108 may comprise an adaptor plate 114 with an interface (identified in FIGS. 6-10). In other embodiments, the adaptor 108 may be any type of fixture by which to connect and/or interface with the end effector 102 and/or the robot flange 106. The adaptor 108 is disposed between the end effector 102 and the robot flange 106 when the end effector 102 is coupled to the robot flange 106. In some embodiments, the adaptor 108 may be sterilized and reused. In other embodiments, the adaptor 108 may be disposable.

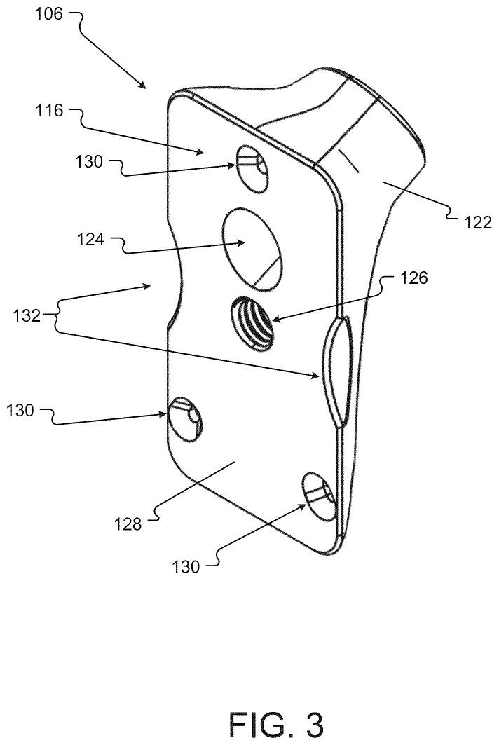

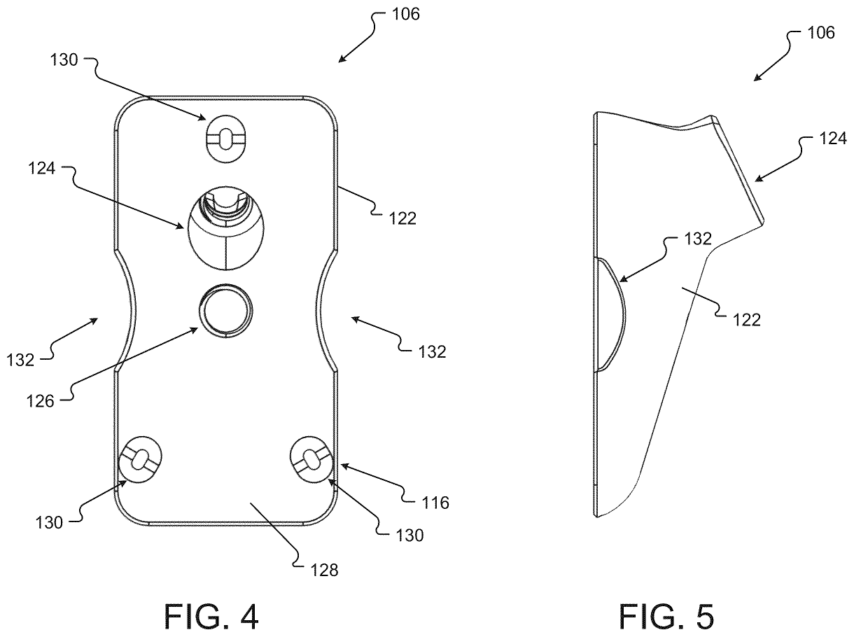

During use, the robot flange 106 is positioned at an end of the robotic arm 104 and includes a first receiver 116 (shown in FIGS. 3 and 4), which may be a first kinematic receiver. The end effector 102 includes a second receiver 118 (visible in FIGS. 13 and 15), which may be a second kinematic receiver, and the adaptor 108 includes an adaptor interface 120 (shown in FIGS. 6-9), which may be a kinematic interface, that is receivable by the first receiver 116 and the second receiver 118. The first receiver 116 and the second receiver 118 may be any type of receiver and the adaptor interface 120 may be any kind of interface. The adaptor interface 120 and the first receiver 116 enable the alignment of the adaptor 108 to the robot flange 106 in a specific orientation and similarly, the adaptor interface 120 and the second receiver 118 enable the alignment of the adaptor 108 to the robot flange 106 in a specific orientation. Further, the adaptor interface 120 has a near zero tolerance, thus substantially maintaining an accuracy of the system 100.

Turning to FIGS. 3-5, an isometric view, a front view, and a side view of the robot flange 106 are respectively shown. The robot flange 106 includes a body 122 connectable to the robotic arm 104. The body 122 includes an aperture 124, though in some embodiments the body may not include the aperture 124. The aperture 124 is configured to receive a screw to the robot flange 106 to a robotic arm. The body 122 also includes a threaded bore 126 configured to receive a screw 134 of the adaptor 108 to secure the adaptor 108 to the robot flange 106. As previously described, the robot flange 106 includes the first receiver 116 disposed on a first mating surface 128 of the body 122. As illustrated, the first receiver 116 comprises three semi-conical depressions or recesses 130 by which to receive the adaptor interface 120 when the adaptor interface 120 comprises three corresponding projections 136. In other instances, the first receiver 116 may comprise any number of depressions 130 and the adaptor interface 120 may comprise any number of projections 136. Each depression or recess 130 may have a diameter substantially the same as the corresponding projection 136 or may have a diameter less or greater than the corresponding projection 136. The first mating surface 128 is generally rectangular shaped and includes a pair of opposing cutouts 132 configured to receive a corresponding pair of tabs 146 of the adaptor 108. It will be appreciated that in other embodiments the first mating surface 128 may be any shape such as, for example, oval, square, triangular, etc. The robot flange 106 may comprise a solid metal such as, for example, stainless steel. In other embodiments, any metal or solid may be used.

Turning to FIG. 6-10, an exploded view, a front isometric, a rear tilted view, a front view, and a side view of the adaptor 108 are respectively shown. As shown in the illustrated embodiment, the adaptor 108 comprises an adaptor plate 114, a torque sleeve 138, a torque sleeve spacer 140, the screw 134, a screw spacer 142, a plurality of projections 136, and a corresponding plurality of projection spacers 144. In the illustrated embodiment, the adaptor plate 114 is rectangular with a cutout 148 and the pair of tabs 146. It will be appreciated that the adaptor plate 114 may be any shape or size and may not include the cutout 148 and/or the pair of tabs 146. In embodiments where the adaptor plate 114 includes the pair of tabs 146, the pair of tabs 146 may be received by the pair of opposing cutouts 132 of the robot flange 106. The pair of tabs 146 and the pair of opposing cutouts 132 may act as a key to ensure that the correct adaptor 108 is used with the correct robot flange 106. Other forms of a key may be used such as, for example, snap tabs, a keyed projection and corresponding receiver, etc.

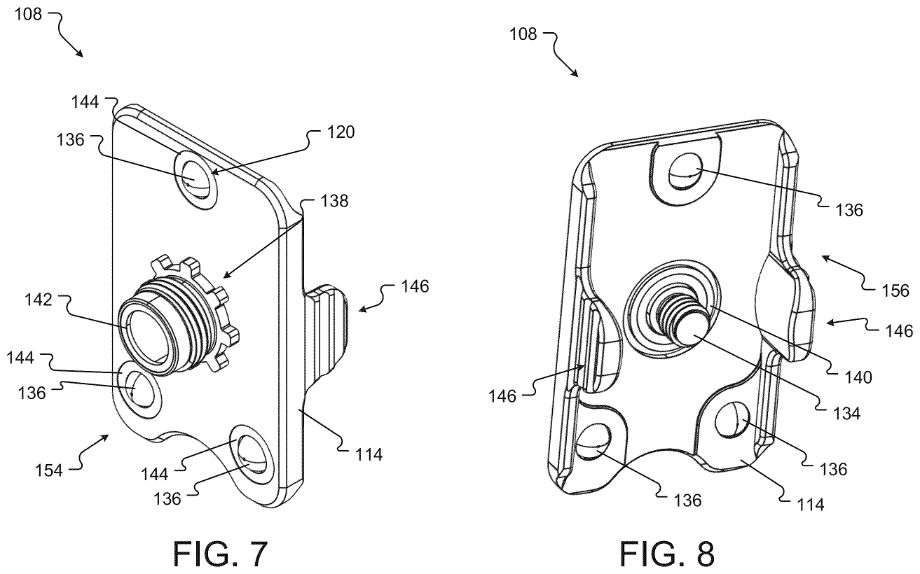

The adaptor plate 114 also includes a sleeve bore 150 configured to receive the torque sleeve 138 and a plurality of projection bores 152 for receiving the corresponding plurality of projections 136. As shown in FIG. 7, the plurality of projections 136 are held in place in the plurality of projection bores 152 by the plurality of projection spacers 144. When the plurality of projections 136 are in place, each of the plurality of projections extend from a first side 154 of the adaptor plate 114 and from a second side 156 opposite the first side 154 of the adaptor plate 114. Thus, the plurality of projections 136 are receivable by the first receiver 116 of the robot flange 106 on the first side 154 and the second receiver 118 of the end effector 102 on the second side 156. In the illustrated embodiment, the plurality of projections 136 are spherical, though in other embodiments the plurality of projections 136 may be any shape or size. The spacing and/or pattern of the plurality of projections 136 may be a unique pattern such that the first receiver 116 and/or the second receiver 118 may only align with the adaptor interface 120 in a specific orientation.

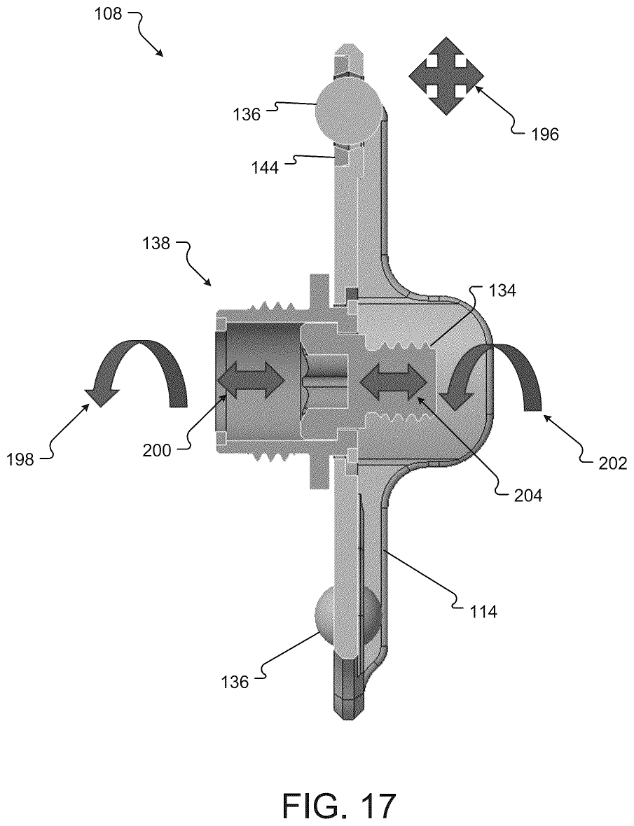

As shown in FIG. 8, the torque sleeve 138 is held in place within the sleeve bore 150 by the torque sleeve spacer 140 and the screw 134 is held in place within the torque sleeve 138 by the screw spacer 142. The plurality of projection spacers 144, the screw spacer 142, and the torque sleeve spacer 140 may be secured in place using, for example, welding or adhesion. In some embodiments, the plurality of projection spacers 144, the screw spacer 142, and the torque sleeve spacer 140 may be held in place via a snap fit. As illustrated in FIG. 17 and will be discussed in more detail, the plurality of projections 136, the screw 134, and the torque sleeve 138 are rotatable and can move translationally within the adaptor plate 114 prior to use.

The torque sleeve 138 includes a torque sleeve bore 158 in which the screw 134 is disposed in. The torque sleeve 138 also includes a patterned flange 160, though in some embodiments the torque sleeve 138 may not include the patterned flange 160. The patterned flange 160 is receivable by a corresponding patterned cutout 162 in the end effector 102 to ensure a correct alignment between the end effector 102 and the adaptor plate 114. As illustrated, the patterned flange 160 comprises a star pattern, though in other embodiments, the patterned flange 160 may comprise any pattern. The torque sleeve 138 also includes an external thread 164 onto which a nut 166 from the end effector 102 can be threaded to. During installation, when the screw 134 is tightened, a shoulder of the screw 134 is tightened against the surface 128 of the robot flange 106. At this stage, the torque sleeve 138 and the adaptor 108 are each free to move (e.g., the torque sleeve 138 is free to spin). When the end effector 102 is attached to the adaptor 108, the torque sleeve 138 engages with the patterned cutout 162 and carries the torque load of nut 166.

As illustrated and previously described, the screw 134 is positioned in the torque sleeve 138 and is configured to be threaded into or received by the threaded bore 126 of the robot to secure the adaptor plate 114 to the robot flange 106. The screw 134 includes a driver interface 168 configured to receive a driver 170 such as, for example, a screw driver to drive the screw 134 into the threaded bore 126. In the illustrated embodiment the driver interface 168 comprises a star interface commonly known as TORX® for use with a star driver commonly known as a TORX® driver. It will be appreciated that in other embodiments any interface may be used such as, for example hex, a cross interface commonly known as PHILLIPS®, flat head, or the like.

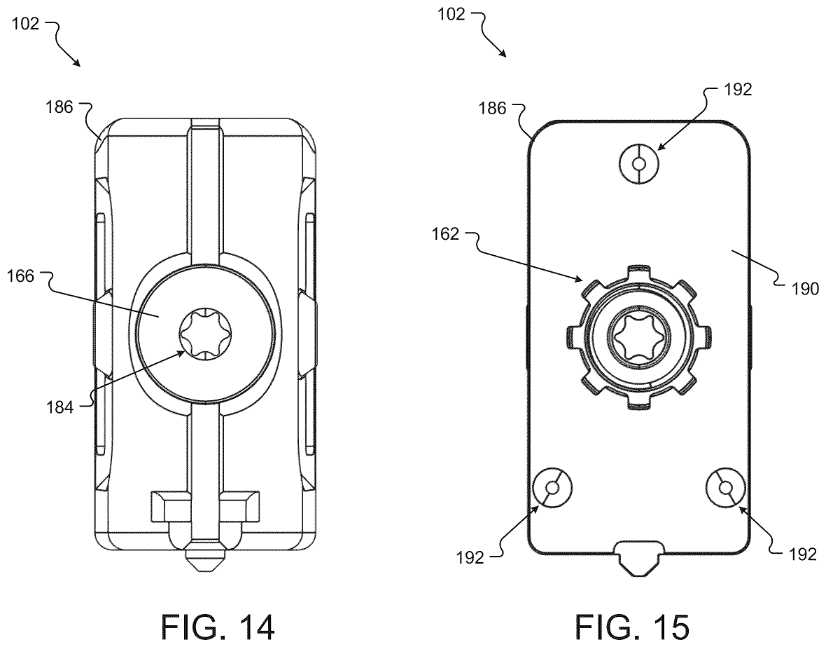

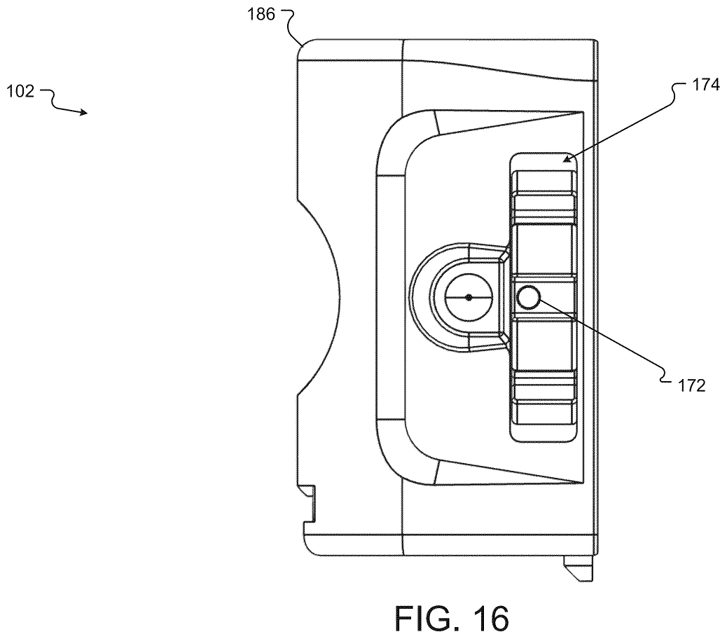

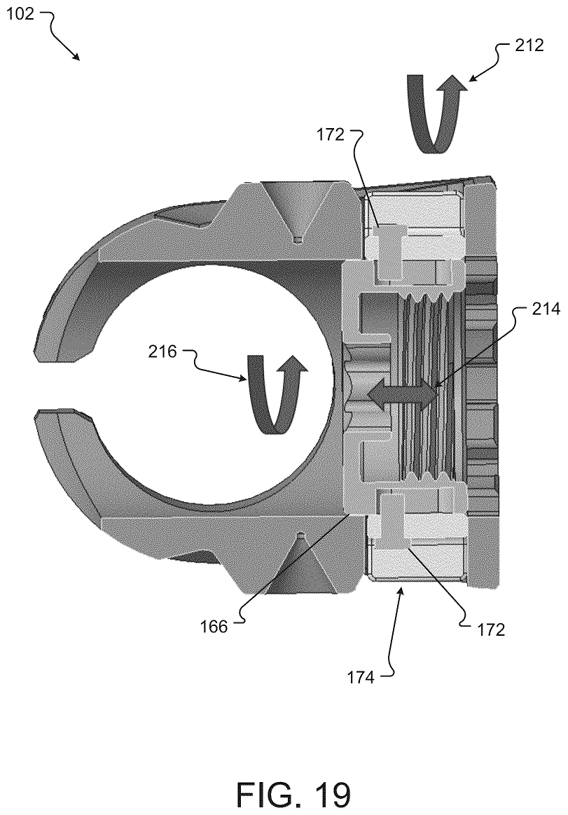

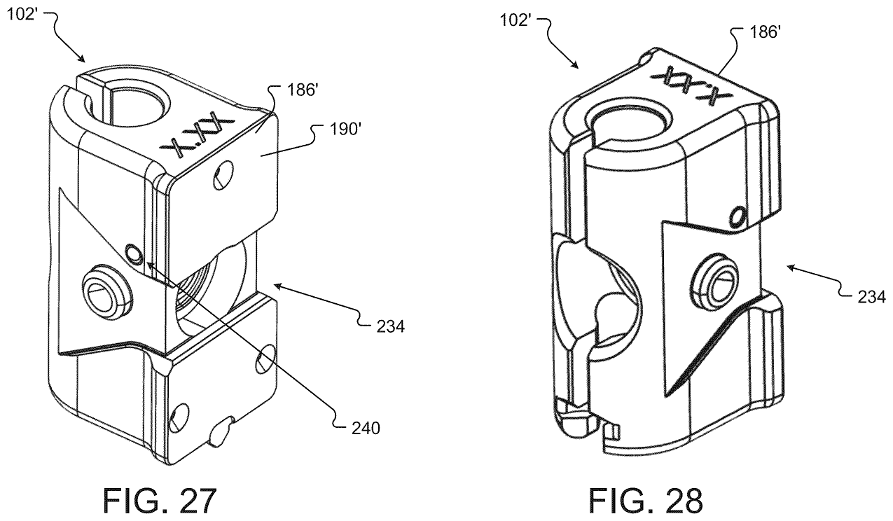

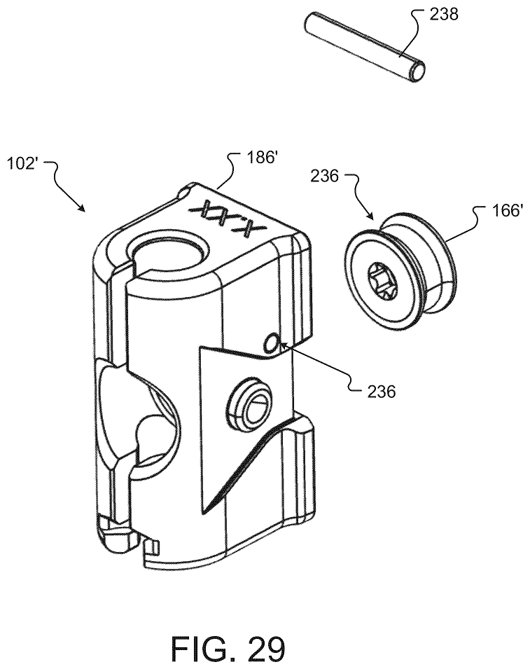

Turning to FIGS. 11-16, an exploded view, an isometric view, a rear tilted view, a front view, a rear view, and a side view of the end effector 102 are respectively shown. The end effector 102 includes an end effector body 186, a nut 166, and a plurality of retaining pins 172 and a retaining wheel 174 for retaining the nut 166 in the end effector body 186. In some embodiments, the end effector 102 may not include the retaining wheel 174 (such as, for example, in the embodiment shown in FIGS. 27-29). When the end effector 102 is assembled, the retaining wheel 174 is positioned in a wheel slot 176 of the end effector body 186, the nut 166 is positioned in a wheel bore 178 of the retaining wheel 174 and each of the plurality of retaining pins 172 are positioned in a pin aperture 182 of the retaining wheel 174 and through a pin slot 180 of the nut 166. The pin slot 180 and the pin 172 enable the nut 166 to translate axially along a center axis of the retaining wheel 174 and relative to the retaining wheel 174, as shown and described in more detail in FIG. 19. During installation, the nut 166 can be threaded onto the external thread 164 of the torque sleeve 138 to secure the end effector 102 to the adaptor 108. Similarly to the screw 134, the nut 166 includes a driver interface 184 configured to receive the driver 170 such as, for example, a screw driver to drive the nut 166 onto the external thread 164. In the illustrated embodiment the driver interface 184 comprises a star interface commonly known as TORX® for use with a star driver commonly known as a TORX® driver. It will be appreciated that in other embodiments any interface may be used such as, for example hex, a cross interface commonly known as PHILLIPS®, flat head, or the like. In some embodiments the same driver 170 can be used with the screw 134 and the nut 166. In other embodiments, a different driver 170 may be used for each of the screw 134 and the nut 166.

The end effector body 186 also includes a guide bore 188 through which the driver 170 can be inserted through to reach the nut 166. The end effector 102 includes an instrument bore 112 perpendicular to the guide bore 188 and configured to receive an instrument or tool. As previously described, the instrument bore 112 may have a fixed inner diameter or an inner diameter that can vary to accommodate a small range of diameters. It will be appreciated that in other embodiments, the instrument bore 112 may be of any shape, geometry, or size that can be fixed or varied to accommodate instruments of different sizes. Thus, different end effectors 102 may be used for different instruments or tools.

As previously described, the end effector body 186 includes the second receiver 118 disposed on a second mating surface 190 of the end effector body 186. As illustrated, the second receiver 118 comprises three semi-conical depressions or recesses 192 by which to receive the adaptor interface 120 when the adaptor interface 120 comprises three corresponding projections 136. In other instances, the second receiver 118 may comprise any number of depressions 192. Each depression or recess 192 may have a diameter substantially the same as the corresponding projection 136 or may have a diameter less or greater than the corresponding projection 136. The second mating surface 190 is generally rectangular shaped. It will be appreciated that in other embodiments the first mating surface 128 may be any shape such as, for example, oval, square, triangular, ctc. As previously described, the end effector body 186 also includes the patterned cutout 162 that can receive the patterned flange 160 of the adaptor 108.

Turning to FIGS. 17-22, various components, and stages of assembly of the system 100 are shown. FIG. 17 illustrates a cross-sectional side view of the adaptor 108. As shown, the plurality of projections 136 when secured in the adaptor plate 114 (via the plurality of projection spacers 144) are able to move in the direction of the arrows 196 and are able to rotate freely. The torque sleeve 138 is also free to rotate about a center axis of the sleeve bore 150 in the direction of the arrow 198 and is able to translate along the center axis of the sleeve bore 150 in the direction of the arrow 200 relative to the adaptor plate 114. The screw 134 is also free to rotate about the center axis of the sleeve bore 150 in the direction of the arrow 202 and is also able to translate along the center axis of the sleeve bore 150 in the direction of the arrow 204 relative to the torque sleeve 138.

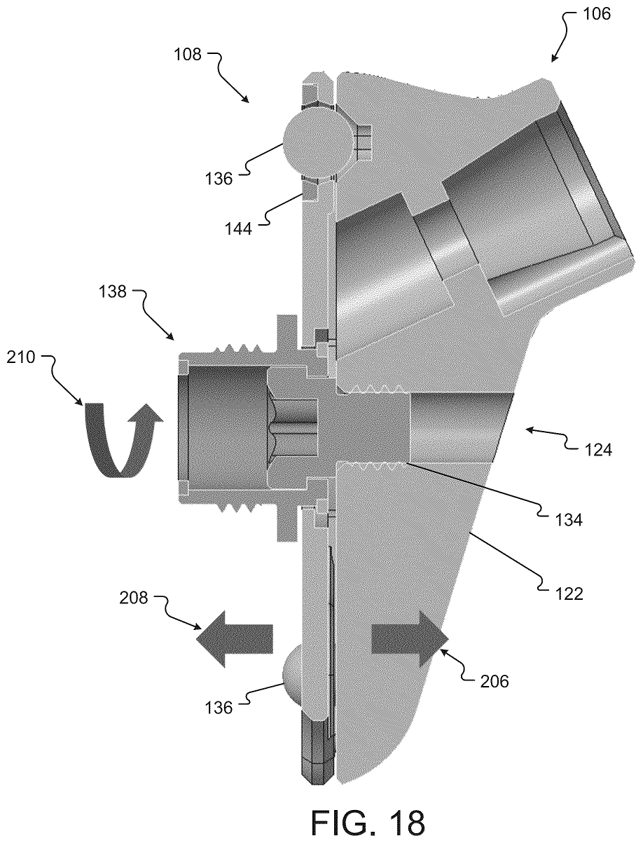

Turning to FIG. 18, a cross-sectional side view of the adaptor 108 engaged with the robot flange 106 is illustrated. As shown, the screw 134 is engaged with the threaded bore 126 of the robot flange 106 until the screw 134 contacts the robot flange 106, thereby securing the adaptor 108 to the robot flange 106. In such configuration, the plurality of projections 136 are received by the corresponding recesses 130 of the first receiver 116. The adaptor plate 114, the plurality of projections 136, and the torque sleeve 138 are each free to move in the direction of the arrows 206, 208 relative to the robot flange 106 and the torque sleeve 138 is rotatable in the direction of the arrow 210 around the center axis of the sleeve bore 150. In other words, the adaptor 108, except for the screw 134, is free-floating. The plurality of projections 136 are also constrained to a zone to ensure nesting (and alignment) with the corresponding recessed 130 when the end effector 102 is assembled.

Turning to FIG. 19, a cross-sectional top view of the end effector 102 is shown. Prior to assembling the end effector 102 onto the adaptor 108, the retaining wheel 174 is free to rotate within the wheel slot 176 and about a center axis of the first end effector bore 188 in the direction of the arrow 212 or in the reverse direction of the arrow 212. The nut 166 is also free to rotate about the center axis of the first end effector bore 188 in the direction of the arrow 214 and within the retaining wheel 174. The nut is also free to move in the direction of the arrow 216 relative to the retaining wheel 174. In such configuration, and as previously described, the retaining wheel 174 and the nut 166 are constrained in the end effector 102 via the wheel slot 176 and the plurality of pins 172 as the end effector 102 is aligned with the adaptor 108.

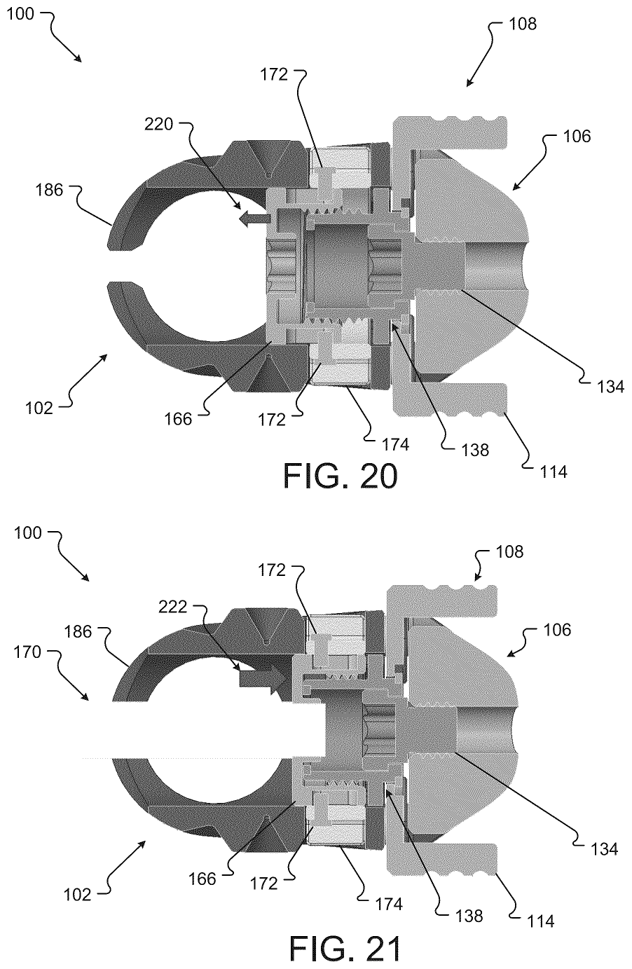

Turning to FIGS. 20 and 21, a cross-sectional top view of the end effector 102 positioned on the adaptor 108 with the nut 166 partially disengaged from the torque sleeve 138 and the nut 166 engaged with the torque sleeve 138 are respectively shown. In FIG. 20, the nut 166 is rotated to translationally move away from the torque sleeve 138 and in the direction of the arrow 220 such that the second receiver 118 of the end effector 102 can be aligned to the adaptor interface 120 and the patterned cutout 162 can be aligned with the patterned flange 160 of the torque sleeve 138. When the second receiver 118 and the patterned cutout 162 are aligned, then the driver 170 is used to advance or thread the nut 166 onto the torque sleeve 138 in the direction of the arrow 222 to secure or lock the end effector 102 to the adaptor 108. The patterned cutout 162 and the patterned flange 160 act as a counter torque when the nut 166 is advanced. Such counter torque feature ensures that the applied forces do not adversely impact an accuracy (e.g., nesting) of the plurality of projections 136 to the corresponding recesses 130.

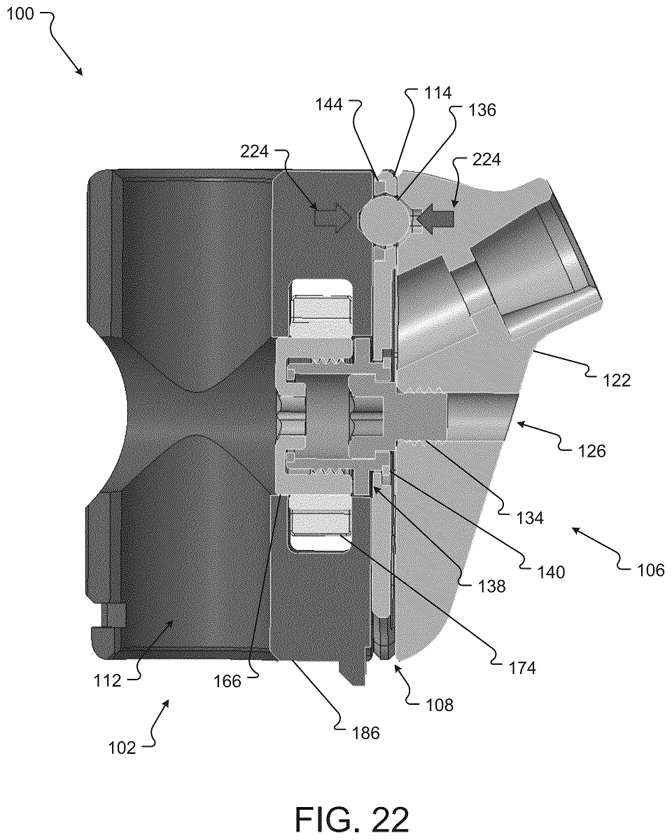

Turning to FIG. 22, a cross-sectional side view of the end effector 102, the adaptor 108, and the robot flange 106 assembled is shown. When the end effector 102 is secured or locked to the adaptor 108, the adaptor plate 114 does not have hard contact with the end effector 102 or the robot flange 106. In other words, the adaptor plate 114 “floats” in between the end effector 102 and the robot flange 106 and holds the plurality of projections 136 in place. When the nut 166 is tightened onto the torque sleeve 138, the plurality of projections 136 are fully seated and centered in the first receiver 116 and the second receiver 118. The plurality of projections 136 are also clamped between the first receiver 116 and the second receiver 118 as indicated by the arrows 224. Because the adaptor plate 114 is not clamped and “floats”, the accuracy of the plurality of projections 136 is unaffected as torque during tightening of the nut 166 onto the torque sleeve 138 is not applied to the adaptor plate 114 and rather, the patterned cutout 162 and the patterned flange 160 act as a counter torque when the nut 166 is advanced. After the nut 166 is tightened, the tension holding or clamping the components together is carried through the screw 134 and the torque sleeve 138. It will be appreciated that the plurality of projections 136 when seated and centered in the first receiver 116 and the second receiver 118 also align the end effector 102 to the robot flange 106.

The system 100 for changing the end effector 102 on the robotic arm 104 as described above beneficially enables changing end effectors 102 during a surgical procedure without breaking the sterile barrier and without substantially affecting an accuracy of the system 100. More specifically, the ability of the adaptor plate 114 to “float” or remain unclamped in between the end effector 102 and the adaptor 108 substantially eliminates unwanted torque being applied to the system 100. Rather, the torque is applied through the screw 134 and the torque sleeve 138. Further, the system 100 does not add additional tolerance stack up.

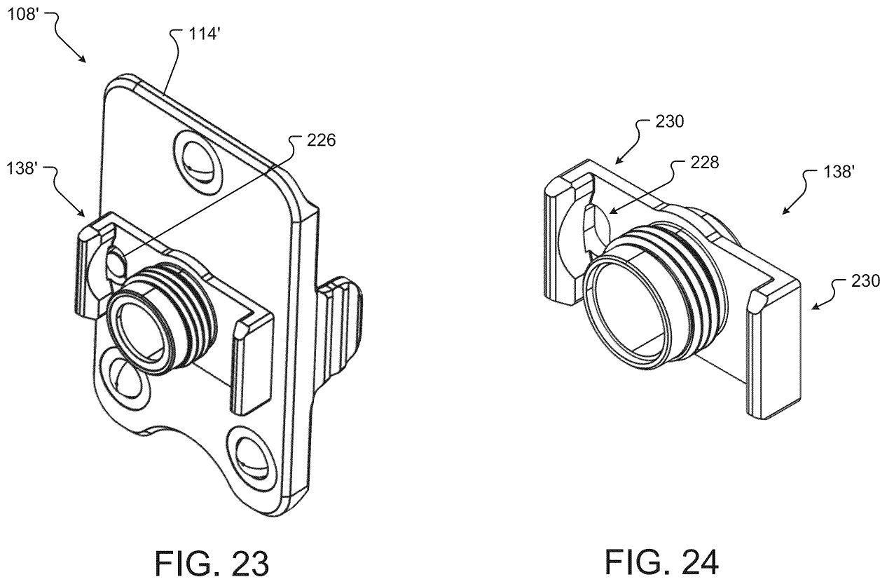

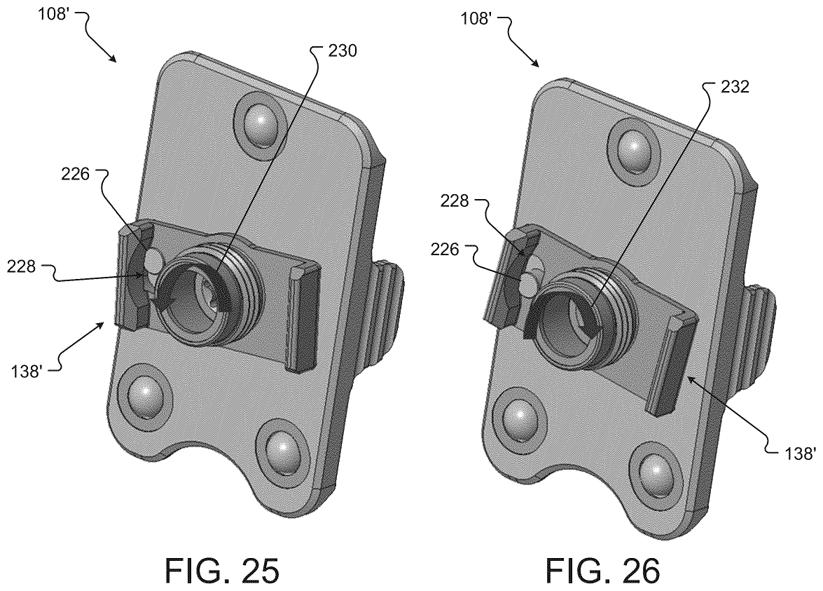

Turning to FIG. 23 an isometric view of another embodiment of an adaptor 108′ according to the present disclosure is shown. FIG. 24 illustrates a torque sleeve 138′ of the adaptor 108′ and FIGS. 25 and 26 illustrate the torque sleeve 138′ on an adaptor plate 114′ of the adaptor 108′ in a first configuration and a second configuration, respectively. The adaptor 108′ may be the same as or similar to the adaptor 108 and includes the adaptor plate 114′ and the torque sleeve 138′.

The adaptor 108′ additionally includes a protrusion 226 protruding from the adaptor plate 114′ and the torque sleeve 138′ includes a protrusion slot 228 for receiving the protrusion 226. The protrusion 226 and the protrusion slot 228 together act as anti-rotation assembly for the torque sleeve 138′, as shown in FIGS. 25 and 26. In the illustrated embodiment, the torque sleeve 138′ is limited to 7 degrees of rotation in one or more directions as shown by the arrows 230, 232, though in other embodiments it will be appreciated that the torque sleeve may be limited to less than or greater than 7 degrees of rotation. The torque sleeve 138′ also includes a pair of aligning tabs 230 that act as a visual aid in placement and assembly of the end effector 102′ onto the adaptor 108′. The pair of aligning tabs 230 may also include one or more lead-in chamfers to facilitate placement of the end effector 102′ onto the adaptor 108′.

Turning to FIGS. 27-29, another embodiment of the end effector 102′ according to the present disclosure in a rear tilted view, an isometric view, and an exploded view are respectively shown. The end effector 102′ is the same as or similar to the end effector 102′ described above and includes an end effector body 186′, a nut 166′, and at least one retaining pin 238. The adaptor 108′ does not include the retaining wheel 174 or the patterned cutout 162. The nut 166′ is retained in the end effector body 186′ by the at least one retaining pin 238 disposed in a corresponding pin slot 140 of the end effector body 186′ and positioned between a recess 236 formed by flanges of the nut 166′ to hold the nut 166′ in place. The nut 166′ can translationally move along and rotate about a center axis of the nut 166′. The end effector body 186′ also includes cutouts or depressions forming a seat 234 to receive the pair of aligning tabs 230 as will be discussed in more detail below.

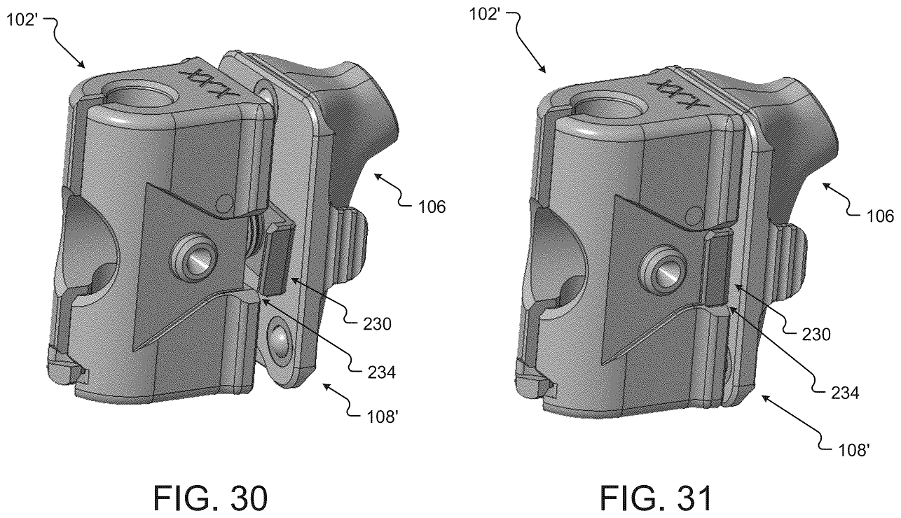

Turning to FIGS. 30 and 31, the end effector 102′ spaced from the adaptor 108′ and the end effector 102′ positioned on the adaptor 108′ are respectively shown. As previously described, the seat 234 of the end effector body 186′ is configured to receive the pair of aligning tabs 230 of the torque sleeve 138′. The seat 234 and the pair of aligning tabs 230 enable the torque sleeve 138′ to center itself when the end effector 102′ is positioned onto the adaptor 108′. Further, the seat 234 and the pair of aligning tabs 230 may be offset from each other so as to prevent the end effector 102′ from being installed upside down onto the adaptor 108′. In other words, the pair of aligning tabs 230 may align with and be receivable by the seat 234 when the end effector 102′ is positioned in the correct orientation relative to the adaptor 108′. When the pair of aligning tabs 230 are engaged with the seat 230, the interaction of the pair of aligning tabs 230 and the seat 230 act as a counter torque when a nut such as the nut 166 is advanced. Such counter torque feature ensures that the applied forces do not adversely impact an accuracy (e.g., nesting) of a plurality of projections such as the plurality of projections 136 to the corresponding recesses such as the recesses 130.

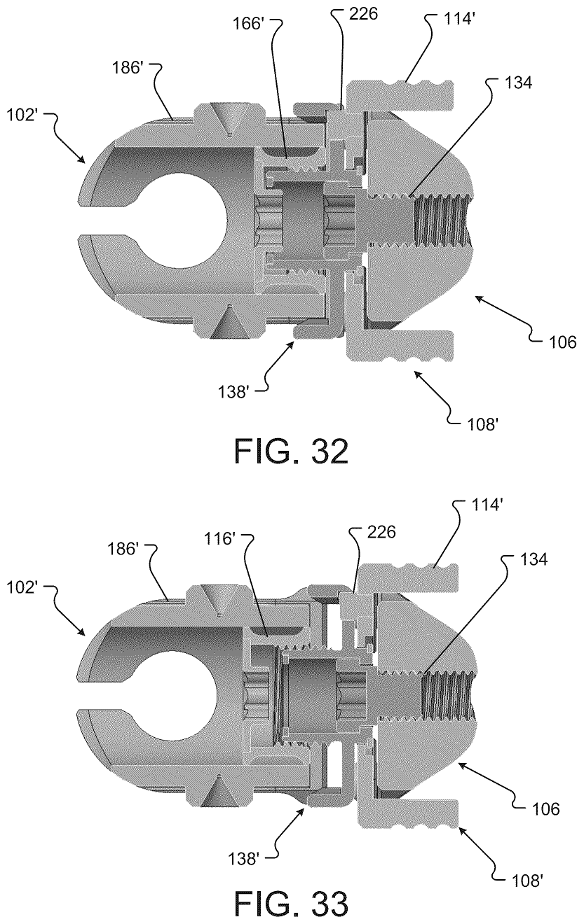

Turning to FIGS. 32 and 33, a cross-sectional top view of the end effector 102′, the adaptor 108′, and the robot flange 106 are shown with the nut 166′ engaged with the torque sleeve 138′ and the nut 166′ semi-disengaged from the torque sleeve 138′, respectively. As shown, the pair of aligning tabs 230 remain engaged with the seat 234 of the end effector body 186′ when the nut 166′ is fully engaged with the torque sleeve 138′ and when the nut 166′ is unthreaded from or disengaged with the torque sleeve 138′. This ensures that the torque sleeve 138′ is engaged when the end effector 102′ is removed from the adaptor 108′, otherwise the torque sleeve 138′ may freely rotate such that the end effector 102′ cannot be removed from the adaptor 108′.

It will be appreciated that the adaptor 108′ and the end effector 102′ may be used with the robot flange 106 and any other component described herein (e.g., the screw 134, the plurality of projections 136, etc.). Further the adaptors 108, 108′ and/or the end effectors 102, 102′ may include any combination of components in addition to the combinations described above.

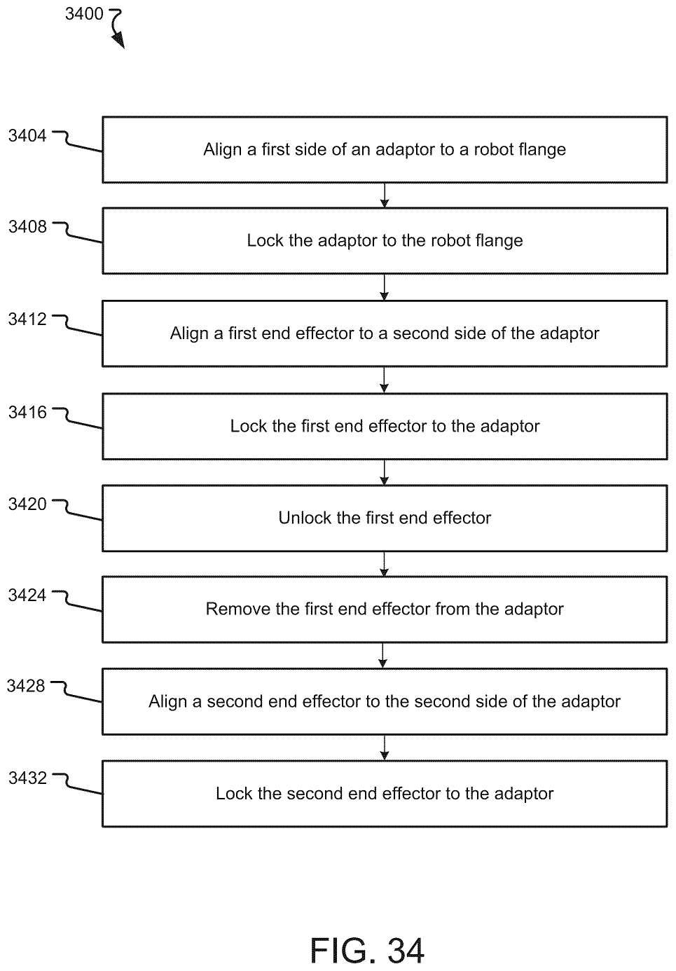

FIG. 34 depicts a method 3400 that may be used, for example, for changing an end effector such as the end effector 102, 102′ using a system such as the system 100 and any of the components described above.

The method 3400 comprises aligning a first side of an adaptor to a first receiver of a robot flange (step 3404). The adaptor may be the same as or similar to the adaptor 108, 108′ and the first receiver may be the same as or similar to the first receiver 116 of a robot flange such as the robot flange 106. The adaptor includes an adaptor interface such as the adaptor interface 120 which may comprise, for example, a kinematic interface having a plurality of projections such as the plurality of projections 136 that extend from the first side and a second side of the adaptor. The first receiver may include a corresponding plurality of depressions such as the depressions or recesses 130 disposed on a first mating surface 128 of the robot flange. The plurality of depressions of the first mating surface are configured to receive the plurality of projections on the first side of the adaptor plate.

The method 3400 also comprises locking the adaptor to the robot flange (step 3408).

The method 3400 also comprises aligning a first end effector to the second side of the adaptor (step 3412). The first end effector may be the same as or similar to the end effector 102, 102′ and includes an end effector body such as the end effector body 186, 186′. The end effector includes a second receiver such as the second receiver 118 that may include a corresponding plurality of depressions or recesses 192 disposed on a second mating surface 190 of the end effector body. The plurality of depressions of the second mating surface are configured to receive the plurality of projections on the second side of the adaptor plate.

The method 3400 also comprises locking the first end effector to the adaptor (step 3416). The first end effector is locked or secured to the robot flange via the adaptor. The adaptor includes a screw such as the screw 134 retained in a torque sleeve such as the torque sleeve 138, 138′. The torque sleeve is retained in the adaptor plate. The screw is received and tightened into a threaded bore such as the threaded bore 126 of the robot flange. After the adaptor is secured to the robot flange, the end effector is positioned on the adaptor. The end effector includes a nut such as the nut 166, 166′ retained in the end effector body. The nut is secured or threaded to an external thread such as the external thread 164 of the torque sleeve, thereby securing or locking the first end effector to the robot flange.

The method 3400 also comprises unlocking the first end effector from the adaptor (step 3420). The first end effector may be unlocked or disengaged from the robot flange by unthreaded or disengage the nut from the screw.

The method 3400 also comprises removing the first end effector from the adaptor (step 3424). In embodiments where the torque sleeve includes a pair of aligning tabs such as the pair of aligning tabs 230, the aligning tabs may also need to be disengaged from the end effector to remove the end effector from the adaptor. In embodiments where the torque sleeve does not include the pair of aligning tabs, the end effector may be simply removed from the adaptor.

The method 3400 also comprises aligning a second end effector to the second side of the adaptor (step 3428). The step 3428 may be the same as or similar to the step 3408 except that the second end effector is a different from the first end effector.

The method 3400 also comprises locking the second end effector to the adaptor (step 3432). The step 34232 may be the same as or similar to the step 3412 except that the second end effector is a different from the first end effector.

It will be appreciated that the steps 3424 and 3428 may be repeated any number of times for any number of end effectors.

It will also be appreciated that a sterile barrier may be maintained between the first end effector and the robot flange and the second end effector and the robot flange when the first end effector is changed for the second end effector because the sterile barrier does not touch the end effector interface. More specifically, the end effector contacts the adaptor on one side of the plurality of projections and the sterile barrier contacts the other side of the plurality of projections. Such sterile barrier provides for interchangeable end effector that can be changed multiple times through a surgical procedure while maintaining a sterile environment.

The present disclosure encompasses embodiments of the method 3400 that comprise more or fewer steps than those described above, and/or one or more steps that are different than the steps described above.

As noted above, the present disclosure encompasses methods with fewer than all of the steps identified in FIG. 34 (and the corresponding description of the method 3400), as well as methods that include additional steps beyond those identified in FIG. 34 (and the corresponding description of the method 3400). The present disclosure also encompasses methods that comprise one or more steps from one method described herein, and one or more steps from another method described herein. Any correlation described herein may be or comprise a registration or any other correlation.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for changing an end effector comprising:
an adaptor comprising:
an adaptor plate having a first side, a second side opposite the first side, and a kinematic interface, the kinematic interface including at least one projection extending from both the first side and the second side;
a torque sleeve retained on the adapter plate; and
a screw disposed inside of the torque sleeve;
an end effector having a body, a kinematic receiver disposed on the body, and a nut, the kinematic receiver including at least one recess for receiving a corresponding projection of the at least one projection of the second side, and
wherein the screw is secured to a robot flange and the nut is secured to the torque sleeve, thereby securing the end effector, the adaptor, and the robot flange to each other.

2. The system of claim 1, further comprising a robot flange having a first kinematic receiver, the first kinematic receiver including at least one recess for receiving a corresponding projection of the at least one projection of the first side.

3. The system of claim 2, wherein the kinematic receiver of the end effector is a second kinematic receiver, and wherein the kinematic interface is received by the first kinematic receiver and the second kinematic receiver when the adaptor plate is positioned between the robot flange and the end effector body.

4. The system of claim 2, wherein a surface of the robot flange is rectangular with a pair of cutouts on opposing sides, wherein the adapter plate comprises a pair of plate tabs configured to engage with the pair of cutouts when the adapter plate is positioned on the robot flange.

5. The system of claim 1, wherein the nut comprises a star drive configured to receive a star driver, the star driver configured to drive the nut onto the screw.

6. The system of claim 1, wherein the torque sleeve comprises a patterned flange.

7. The system of claim 6, wherein the body of the end effector has a patterned cutout for receiving the patterned flange, wherein the nut can be secured to the screw when patterned flange is received by the patterned cutout.

8. The system of claim 7, wherein patterned cutout and the patterned flange each form a star pattern.

9. The system of claim 1, wherein the torque sleeve comprises a pair of aligning tabs and the body of the adapter includes a seat for receiving the pair of aligning tabs.

10. The system of claim 1, wherein the adaptor plate further comprises at least one protrusion and the torque sleeve comprises at least one slot configured to receive the at least one protrusion to control rotation of the torque sleeve about the adaptor plate.

11. The system of claim 1, wherein the end effector comprises a plurality of end effectors, and wherein the adaptor is configured to receive any one end effector of the plurality of end effectors.

12. The system of claim 1, wherein the end effector comprises at least one pin to retain the nut in the body.

13. A system for changing an end effector comprising:
an adaptor comprising:
an adaptor plate having a first side, a second side opposite the first side, and a kinematic interface, the kinematic interface including at least one projection extending from both the first side and the second side;
a torque sleeve retained on the adapter plate, wherein the torque sleeve comprises a patterned flange; and
a screw disposed inside of the torque sleeve;
an end effector having a body, a kinematic receiver disposed on the body, and a nut, the kinematic receiver including at least one recess for receiving a corresponding projection of the at least one projection of the second side, the body having a patterned cutout for receiving the patterned flange, and
wherein the nut can be secured to the screw when the patterned flange is received in the patterned cutout, and
wherein the screw is secured to a robot flange and the nut is secured to the torque sleeve, thereby securing the end effector, the adaptor, and the robot flange to each other.

14. The system of claim 13, further comprising a robot flange having a first kinematic receiver, the first kinematic receiver including at least one recess for receiving a corresponding projection of the at least one projection of the first side.

15. The system of claim 14, wherein the kinematic receiver of the end effector is a second kinematic receiver, and wherein the kinematic interface is received by the first kinematic receiver and the second kinematic receiver when the adaptor plate is positioned between the robot flange and the end effector body.

16. The system of claim 14, wherein a surface of the robot flange is rectangular with a pair of cutouts on opposing sides, wherein the adapter plate comprises a pair of plate tabs configured to engage with the pair of cutouts when the adapter plate is positioned on the robot flange.

17. The system of claim 13, wherein the end effector comprises a plurality of end effectors, and wherein the adaptor is configured to receive any one end effector of the plurality of end effectors.

18. The system of claim 13, wherein the end effector comprises at least one pin to retain the nut in the body.

19. The system of claim 13, wherein the nut comprises a star drive configured to receive a star driver, the star driver configured to drive the nut onto the screw.

20. A system for changing an end effector comprising:
an adaptor comprising:
an adaptor plate having a first side, a second side opposite the first side, and a kinematic interface, the kinematic interface including at least one projection extending from both the first side and the second side;
a torque sleeve retained on the adapter plate; and
a screw disposed inside of the torque sleeve;
a robot flange having a first kinematic receiver, the first kinematic receiver including at least one recess for receiving a corresponding projection of the at least one projection of the first side;
an end effector having a body and a second kinematic receiver disposed on the body, the second kinematic receiver including at least one recess for receiving a corresponding projection of the at least one projection of the second side; and
a nut configured to secure to the torque sleeve,
wherein the kinematic interface is received by the first kinematic receiver and the second kinematic receiver when the adaptor plate is positioned between the robot flange, and
wherein the screw is secured to the robot flange and the nut is secured to the torque sleeve, thereby securing the end effector, the adaptor, and the robot flange to each other.
